(19) United States
(12) Patent Application Publication
(10) Pub. No.: US 2015/0348090 A1
(43) Pub. Date: Dec. 3, 2015

(54) ENGAGEMENT WITH DEVICE AND AD SERVING

(71) Applicant: Apple Inc., Cupertino, CA (US)

(72) Inventors: Thomas Alsina, Mountain View, CA (US); David T. Wilson, Campbell, CA (US)

(73) Assignee: Apple Inc., Cupertino, CA (US)

(21) Appl. No.: 14/288,964

(22) Filed: May 28, 2014

(51) Int. Cl. G06Q 30/02

(52) U.S. Cl. CPC G06Q 30/0244; G06Q 30/0255

(57) ABSTRACT

Disclosed herein are systems, methods, and non-transitory computer-readable storage media for determining user engagement with a client device and selecting from stored content items to present based on the user engagement. The user engagement is based on the operation and configuration of the device. Invitational content items are evaluated and presented according to the user engagement with the client device.

### TECHNICAL FIELD

The present technology pertains to presenting invitational content, and more specifically pertains to intelligently selecting invitational content based on user engagement with a mobile device.

### BACKGROUND

Mobile advertising is widely used by advertisers to market their products via mobile devices. Given the widespread availability of mobile devices, mobile advertising can be an extremely effective way for advertisers to reach a wide mass of potential customers and induce numerous users to purchase their products. By targeting mobile users with effective mobile advertisements, advertisers can yield large financial returns from their mobile advertisements.

Many tools are currently available for advertisers to optimize the performance of an advertising campaign. For example, advertisers can target a particular audience based on demographic information such as age, income, gender, ethnicity, level of education, occupation, etc. In addition, advertisers can target users according to the time of delivery for the advertisement and the geographic region.

However, the effectiveness of a mobile advertisement and the likelihood of a conversion depends largely on the attentiveness and disposition of the mobile user at the time the mobile advertisement is delivered. In general, mobile advertisements are delivered to a mobile device without any knowledge of the user's present attentiveness to the mobile device. Consequently, many mobile advertisements are delivered to a mobile device but are ignored or missed entirely because the device user was either not interested in the content or not actively engaged with the device at the time of delivery.

### SUMMARY

Additional features and advantages of the disclosure will be set forth in the description that follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Invitational content items can be delivered to devices without any knowledge of the device user's present engagement or disposition. For example, invitational content items can be broadcasted to all devices on a particular network or within the range of a wireless broadcasting appliance. The approaches set forth herein can be used to intelligently select invitational content for presentation on a device according to the engagement of the device user. User engagement can be gauged by monitoring the device configuration and the device user's interactions with the device while keeping track of the time and the types of interactions to determine the receptiveness of the device user. Disclosed are systems, methods, and non-transitory computer-readable storage media for creating and processing the present technology.

One aspect of the present technology involves a method to determine a user engagement mode for a client device. The user engagement mode is based on at least one event that is detected on the client device. The detected event can include a device configuration event and a device operation event. Based on the user engagement mode, the device selects at least one invitational content item and presents that invitational content item on the client device.

The invitational content items can be associated with at least one inclusion criterion and at least one exclusion criterion. The inclusion criterion and the exclusion criterion can be compared and filtered according to the user engagement mode.

The device operation can include launching or using an application on the client device. The device operation can also include device movements obtained from sensors on the device. The device movements detected can be stationary, walking, or running. The device configuration can include a wireless configuration, an audio configuration, or a notification configuration. In addition, the user engagement mode can also be based on the time elapsed from the detection of an event.

After an invitational content item is presented, the device can send an acknowledgement that it was presented. Furthermore, the device can predict future user engagement based on its historical data and it can evaluate and discard invitational content items according to the future user engagement it predicted.

Another aspect of the present technology involves a method for computing device tags for a client device. The device tags are based on at least one event that is detected on the client device. The detected event can include a device configuration event and a device operation event. Based on the device tags, the device selects at least one invitational content item and presents that invitational content item on the client device.

The invitational content items can each include an inclusion tag and an exclusion tag. The inclusion tag and the exclusion tag can be compared to the device tags and the invitational content item can be assigned a confidence score according to the comparison. The invitational content items can also be filtered according to the assigned confidence score.

The device tags can also be based on the time that has elapsed since a user event was detected.

A further aspect of the present technology involves a non-transitory computer-readable storage medium that has instructions which cause a processor to determine a user engagement mode for a client device. The user engagement mode is based on at least one event that is detected on the client device. The detected event can include a device configuration event and a device operation event. Based on the user engagement mode, the device selects at least one invitational content item and presents that invitational content item on the client device.

The user engagement mode can also be used to formulate a filter function. The filter function can be used to filter each invitational content item according to presentation criterion that includes one or both of an inclusion criterion or an exclusion criterion.

Yet a further aspect of the present technology involves a client device that has a communications interface, a processor, and a computer-readable medium. The computer-readable medium can have instructions stored that cause the processor to compute device tags for a client device. The device tags are based on at least one event that is detected on the client device. The detected event can include a device configuration event and a device operation event. Based on the device tags, the device selects at least one invitational content item and presents that invitational content item on the client device.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary configuration of devices and a network;

FIG. 2 illustrates an exemplary user terminal;

FIG. 3 illustrates an exemplary method embodiment;

FIG. 4 illustrates an exemplary invitational content item and device; and

FIG. 5A and FIG. 5B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosed technology addresses the need in the art for an efficient means to determine user engagement with a device and present invitational content items according to the user engagement. In particular, the present technology is directed to systems, methods, devices, and non-transitory computer-readable storage media providing selection of invitational content based on user engagement with a device when the device receives multiple broadcasted invitational content items.

Prior to discussing the present technology in detail, a brief introductory description of an exemplary configuration of devices and a network is disclosed herein. A detailed description of the various aspects of the present technology will then follow. These variations shall be described herein as the various embodiments are set forth.

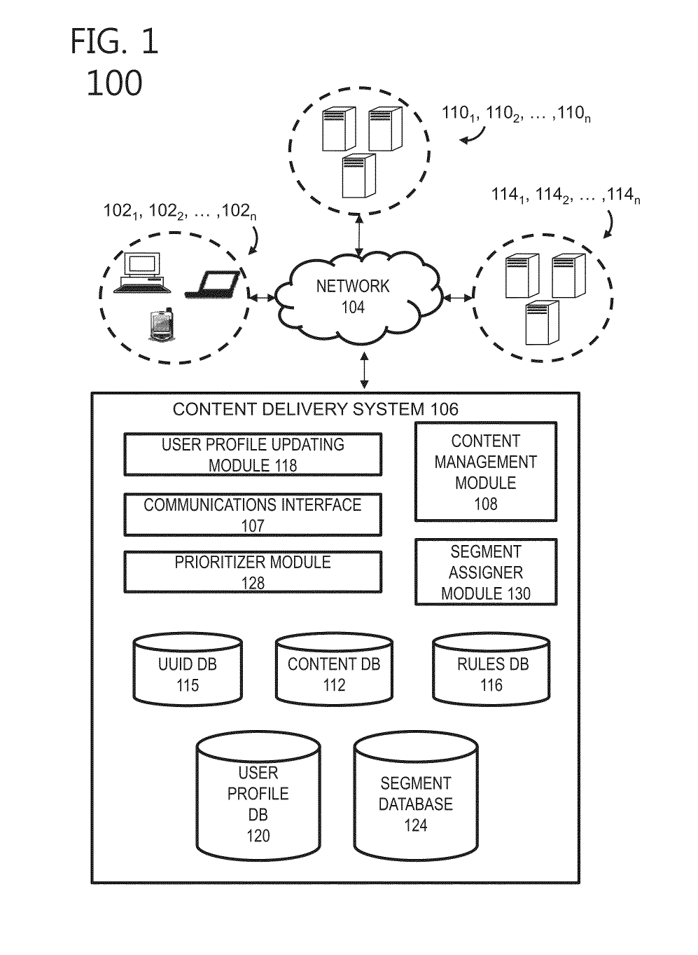

An exemplary system configuration 100 is illustrated in FIG. 1, wherein electronic devices communicate via a network for purposes of exchanging content and other data. The system can be configured for use on a wide area network such as that illustrated in FIG. 1. However, the present principles are applicable to a wide variety of network configurations that facilitate the intercommunication of electronic devices. For example, each of the components of system 100 in FIG. 1 can be implemented in a localized or distributed fashion in a network.

In system 100, invitational content can be delivered to user terminals 102₁, 102₂, . . . , 102ₙ (collectively “102”) connected to a network 104 by direct and/or indirect communications with a content delivery system 106. User terminals 102 can be any network enabled client devices, such as desktop computers; mobile computers; handheld communications devices, e.g. mobile phones, smart phones, tablets; smart televisions; set-top boxes; and/or any other network enabled computing devices. Furthermore, content delivery system 106 can concurrently accept connections from and interact with multiple user terminals 102.

The content delivery system 106 can receive a request for electronic content, such as a web page, an application, a media item, etc., from one of user terminals 102. Thereafter, the content delivery system 106 can assemble a content package and transmit the assembled content page to the requesting one of user terminals 102. To facilitate communications with the user terminals 102 and/or any other device or component, the content delivery system 106 can include a communications interface 107.

The content delivery system 106 can include a content management module 108 to facilitate the generation of an assembled content package. Specifically, the content management module 108 can combine content from one or more primary content providers 110₁, 110₂, . . . , 110ₙ (collectively “110”) and content from one or more secondary content providers 114₁, 114₂, . . . 114ₙ (collectively “114”) to generate the assembled content package for the user terminals 102. For example, in the case of a web page being delivered to a requesting one of user terminals 102, the content management module 108 can assemble a content package by requesting the data for the web page from one of the primary content providers 110 maintaining the web page. For the invitational content on the web page provided by the secondary content providers 114, the content management module 108 can request the appropriate data according to the arrangement between the primary and secondary content providers 110 and 114. Additionally, the content management module 108 can create content packages that contain content from a single content provider. That is, a content package can contain only primary content or a content package can contain only secondary content. However, the content package is not limited to the content from content providers 110 and 114. Rather, the content package can include other data generated at the content delivery system 106.

In some embodiments, the content delivery system 106 can preselect the content package before a request is received. For example, the content delivery system 106 can be a broadcasting appliance that targets user terminals 102 within a localized geographic area or user terminals 102 that are part of network 104, such as a local area network or a personal area network. The content delivery system 106 can send the package to the user terminals 102 that have authenticated with network 104, without any individualized information used to target the particular user terminal 102.

An assembled content package can include text, graphics, audio, video, executable code, or any combination thereof. Further, an assembled content package can include invitational content designed to inform or elicit a pre-defined response from the user. In some embodiments, the invitational content can be associated with a product or can directly or indirectly advertise a product. For example, the assembled content package can include one or more types of advertisements from one or more advertisers.

Additionally, the invitational content can be active invitational content. That is, invitational content that is designed to primarily elicit a pre-defined response from a user. For example, active invitational content can include one or more types of advertisements configured to be clicked upon, solicit information, or be converted by the user into a further action, such as a purchase or a download of the advertised item. However, invitational content can also be passive invitational content. That is invitational content that is designed to primarily inform the user, such as a video. In some cases, passive invitational content can include information that can lead or direct users to other invitational content including active invitational content.

Furthermore, the invitational content can be dynamic invitational content. That is invitational content that varies over time or that varies based on user interaction. For example, dynamic invitational content can include an interactive game. However, the various embodiments are not limited in this regard and the invitational content can include static invitational content that neither varies over time nor with user interaction. In the various embodiments, invitational content in a content package can be static or dynamic and active or passive. A content package can include a combination of various types of invitational content in a single content package.

In some cases, a content package can replace or update invitational content in a content package already delivered to a user terminal. For example, a first content package can include an app that can be installed on the user terminal 102ᵢ. A subsequent content package can include one or more items of invitational content that can be presented to a user of the user terminal 102, while the user interacts with the app.

Although primary and secondary providers 110 and 114 are presented herein as separate entities, this is for illustrative purposes only. In some cases, the primary and the secondary content providers 110 and 114 can be the same entity. Thus, a single entity can provide both the primary and the secondary content.

The content management module 108 can be configured to request that content be sent directly from content providers 110 and 114. Alternatively, a cached arrangement can also be used to improve performance of the content delivery system 106 and improve overall user experience. That is, the content delivery system 106 can include a content database 112 for locally storing/caching content maintained by content providers 110 and 114. The data in the content database 112 can be refreshed or updated on a regular basis to ensure that the content in the database 112 is up to date at the time of a request from a user terminal 102i. However, in some cases, the content management module 108 can be configured to retrieve content directly from content providers 110 and 114 if the metadata associated with the data in the content database 112 appears to be outdated or corrupted.

As described above, content maintained by the content providers 110 and 114 can be combined according to a predefined arrangement between the two content providers, which can be embodied as a set of rules. In an arrangement where the content delivery system 106 assembles the content package from multiple content providers, the assembly rules can be stored in a rules database 116 in the content delivery system 106. The content management module 108 can be configured to assemble the content package for user terminals 102 based on these rules. The rules can specify how to select content from secondary content providers 114 and primary content providers 110 in response to a request from one of user terminals 102. For example, in the case of a web page maintained by one of primary content providers 110 and including invitational content, the rules database 116 can specify rules for selecting one of the secondary providers 114. The rules can also specify how to select specific content from the selected one of secondary providers 114 to be combined with the content provided by one of primary providers 110. In some cases, an item of primary content, such as an app or other media object, can have one or more associated attributes. For example, an app can have one or more associated genre attributes, e.g. travel, sports, education, etc. A rule can be based at least in part on the primary content attributes. Once assembled, the assembled content package can be sent to a requesting one of user terminals 102.

Additionally, rules for combining primary and secondary content can be based on user characteristics known about the user. In particular, in some cases, invitational content can be selected based on the characteristics of the requesting user(s). As used herein, the term “user characteristics” refers to the characteristics of a particular user associated with one or more of user terminals 102. User characteristics can include channel characteristics, demographic characteristics, behavioral characteristics, and spatial-temporal characteristics. Channel characteristics can define the specific delivery channel being used to deliver a content package to a user. For example, channel characteristics can include a type of electronic content, a type of device or user terminal, a carrier or network provider, or any other characteristic that defines a specific delivery channel for the content package. Spatial-temporal characteristics can define a location, a location zone, a date, a time, or any other characteristic that defines a geographic location and/or a time for delivery of the content package. Demographic characteristics can define characteristics of the users targeted by the content or associated with the content. For example, demographic characteristics can include age, income, ethnicity, gender, occupation, or any other user characteristics. Behavioral characteristics can define user behaviors for one or more different types of content, separately or in combination with any other user characteristics. That is, different behavioral characteristics may be associated with different channel, demographic, or spatial-temporal characteristics. User characteristics can also include characteristics descriptive of a user's state of mind including characteristics indicative of how likely a user is to click on or convert an item of invitational content if it were displayed to the user. User characteristics can be learned directly or derived indirectly from a variety of sources. In some embodiments, the user characteristic values can be collected from one or more databases. For example, if the user is registered with an online media service, such as the ITUNES store maintained by Apple Inc. of Cupertino, Calif., the collected data could include the user's registration information. Such data can provide values for declared user characteristics. Furthermore, the content delivery system 106 can be configured to learn of or derive user characteristics from any number of other information sources. For example, in some configurations, the content delivery system 106 can derive or infer one or more user characteristic values from user characteristic values already known about the user.

In some embodiments, the interactive content can be associated with one or more targeted segments. A targeted segment can be viewed as defining a space or region in k-dimensional space, where each of the k dimensions is associated with one of a number of user characteristics. In the various embodiments, the k dimensions can include both orthogonal and non-orthogonal dimensions. That is, some of the k dimensions can overlap or can be related in some aspect.

In the various embodiments, the content delivery system 106 can also include a unique user identifier (UUID) database 115 that can be used for managing sessions with the various user terminal devices 102. The UUID database 115 can be used with a variety of session management techniques. For example, the content delivery system 106 can implement an HTTP cookie or any other conventional session management method (e.g., IP address tracking, URL query strings, hidden form fields, window name tracking, authentication methods, and local shared objects) for user terminals 102 connected to content delivery system 106 via a substantially persistent network session. However, other methods can be used as well. For example, in the case of handheld communications devices, e.g. mobile phones, smart phones, tablets, or other types of user terminals connecting using multiple or non-persistent network sessions, multiple requests for content from such devices may be assigned to a same entry in the UUID database 115. The content delivery system 106 can analyze the attributes of requesting devices to determine whether such requests can be attributed to the same device. Such attributes can include device or group-specific attributes.

In some embodiments, the content delivery system 106 can include a user-profile database 120. The user-profile database 120 can, at least in part, be constructed based on declared user characteristics related to one or more users. In some cases, the user-profile database may contain inferred or derived user characteristic values. The user-profile database 120 can be updated using a user-profile updating module 118. In some embodiments, the user-profile updating module 118 can be configured to add additional profile data, update profile data, fill in missing profile data, or infer user characteristic values from declared data.

The user-profile updating module 118 can also be configured to maintain the user-profile database 120 to include only more recently acquired data or to re-derive any inferred characteristics in order to ensure that the user profile is an accurate reflection of the current state of the user (location, state of mind, behaviors, demographics, etc. can change rapidly). For example, the user-profile updating module 118 can be configured to maintain the user-profile database 120 to include only data from the last two to three months. However, the user-profile updating module 118 can be configured to adjust the data in the user-profile database 120 to cover any span of time. In some instances the user-profile updating module 118 can update the profile database 120 in real-time. Alternatively, the user-profile updating module 118 can be configured to set an expiration period on a subset of the data in the user-profile database 120. For example, a policy can specify that user declared data is maintained as long as the user account is active, but user characteristic values based on location information expire after a specified period of time. In some cases, a user can set the expiration period. In some instances, the user-profile updating module 118 can update the user-profile database 120 at least every week, or every day. In some cases, the content delivery system 106 can receive a direct request to update one or more user profiles. The update request can come directly from the user's device or any other device capable of communicating with the content delivery system 106, such as other content delivery networks or websites. In some cases, the content delivery system 106 can receive an indirect request to update one or more user profiles. An indirect request can be the result of receiving new user characteristic values. An update request can occur at any time.

In some embodiments, the content delivery system 106 can include a segment database 124 that is used to aid in selecting invitational content to target to users. The segment database 124 can store defined segments and associations between the segments and users and/or invitational content that should be targeted to users associated with the segments. As described above, a targeted segment can be defined based on one or more user characteristics or derivatives thereof and can be associated with one or more items of invitational content. Additionally, a targeted segment can be associated with one or more users. In some embodiments, by associating a targeted segment with both a user and an item of invitational content, the delivery system can match invitational content with users. In some embodiments, the content delivery system 106 can update the segment database 124 to add newly defined targeted segments or to delete targeted segments.

In some cases a targeted segment can be as simple as a single user characteristic identifier and a single user characteristic value. For example, the common demographic identifiers of gender, age, occupation, or income can each be used in defining corresponding targeted segments. A characteristic value can also be assigned to the identifier. For example, the values of male, 19, and student can be assigned to the user characteristics of gender, age, and occupation, respectively. However, more complex targeted segments can also be defined that consist of one or more identifiers with one or more values associated with each identifier. For example, a targeted segment can be defined to target a user with the following characteristics: gender, male; age, 19-24; location, Northern California or New York City. Furthermore, targeted segments can correspond to one or more segments that content providers are likely to easily understand and thus can quickly identify as being relevant to their content. Additionally, in some embodiments, content providers 110 and 114 can define a custom targeted segment.

In some embodiments, the content delivery system 106 can provide a segment assigner module 130. The segment assigner module 130 can apply a set of user characteristics associated with a user (including segments to which a user has been previously assigned) to assign the user to one or more targeted segments. The assigner module 130 can obtain the set of user characteristic values from the user-profile database 120 and/or from the user's activities during the current session. The segment assigner module 130 can assign a user to one or more defined targeted segments in the segment database 124, or alternatively, a user can be assigned to a custom targeted segment defined to meet specific goals of a content provider.

Based on the assigned segments, the user-profile database 120 can be updated to reflect the segment assignments. Additionally, the content delivery system 106 can use the segment assignments to select targeted content. In some cases, the user profile data in the user-profile database 120 can change over time so the segment assigner module 130 can be configured to periodically update the segment assignments in the user-profile database 120. The segment assignment update can be triggered at specified intervals, upon detection of a change in the user-profile database 120, and/or upon detection of a specified activity in the content delivery system 106.

In some embodiments, the content delivery system 106 can provide a prioritizer module 128. The prioritizer module 128 can perform a variety of prioritizing tasks based on the configuration of the content delivery system 106. In some configurations, the prioritizer module 128 can prioritize the targeted segments assigned to a user. The prioritization can be influenced by a number of factors, which can include the user's context, a content provider's campaign goals, and/or the content that is currently available for display to the user. A request to prioritize the targeted segments can be explicit or implicit and can be made by any component of the system 100. For example, a secondary content provider 114 can explicitly request that the content delivery system 106 prioritize the targeted segments or the request can be implicit as part of a request for a content package. The resulting prioritized list can be provided, for example, to the content management module 108, which can then use the information to assemble and deliver a content package. Additionally, the prioritized list can be stored, for example in the user profile, for later use.

While the content delivery system 106 is presented with specific components, it should be understood by one skilled in the art, that the architectural configuration of system 106 is simply one possible configuration and that other configurations with more or less components are also possible.

One aspect of the present technology is the gathering and use of data available from various sources to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, or any other identifying information.

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publically available information.

Now that some basic concepts have been set forth, the present disclosure turns to a more detailed description of the present technology. As discussed above, the present technology is directed to systems and methods to assess user engagement and select invitational content for delivery based on the user engagement. The following figures provide exemplary systems and methods for practicing the present technology.

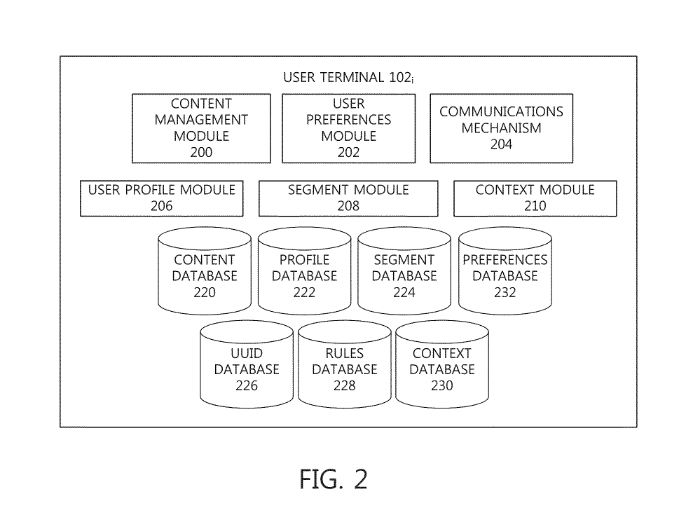

The disclosure now turns to FIG. 2, which illustrates an exemplary configuration of a client device. The client device, user terminal 102i, can include a content management module 200. The content management module 200 can manage and facilitate the generation and presentation of a content package. In some cases, the content management module 200 can combine content from local storage on the user terminal 102i, content delivery system 106, one or more primary content providers 110, and one or more secondary content providers 114, to generate or assemble a content package for the user terminal 102i. For example, in the case of a web page being delivered to user terminal 102i, the content management module 200 can assemble a content package by requesting the data for the web page from the content delivery system 106 or one of the primary content providers 110 maintaining the web page. For the invitational content on the web page provided by the secondary content providers 110, the content management module 200 can request the appropriate data according to the arrangement between the primary and secondary content providers 110 and 114. In some cases, the content management module 200 can request the appropriate data based on various parameters, conditions, rules, circumstances, or preferences at user terminal 102i or content delivery system 106.

Additionally, the content management module 200 can create content packages that contain content from a single content provider. That is, a content package can contain only primary content or a content package can contain only secondary content, for example. However, the content package is not limited to the content from content providers 110 and 114. Rather, the content package can include other data generated at the content delivery system 106 or user terminal 102i. For example, the user terminal 102i can include a content database 220 for locally storing/caching content maintained by user terminal 102i, content delivery system 106, or content providers 110 and 114. The data in the content database 220 can be refreshed or updated on a regular basis to ensure that the content in the database 220 is up to date at the time of a request from user terminal 102i. However, in some cases, the content management module 200 can be configured to retrieve content directly from content providers 110 and 114 if the metadata associated with the data in the content database 220 appears to be outdated or corrupted, for example.

In some embodiments, the content management module 200 can include content-listing functions. The content-listing functions can generate and/or maintain lists of content items, such as invitational content, that are estimated to be of interest to a user. The content-listing functions can also generate and/or maintain lists of places of interest for a user. The items in any particular list generated or maintained by the content-listing functions can be selected based on location data associated with the user terminal 102i, as well as context, profile, segment, or preferences information as further described below. For example, the content-listing functions can generate a specific list of items based on location data from user terminal 102i. The content-listing functions can also identify a geofence for the user terminal 102i based on the location data. The geofence can specify a geographic area or a perimeter, and the content-listing functions can identify and select items associated with the geographic area, for inclusion in a list of items. Thus, the list of items can include items specific to the geographic area. For example, the list of items can include advertisements for businesses located within the geographic area.

The content-listing functions can identify and/or select specific items to include in a list of items from one or more master lists of items or databases. For example, the content-listing functions can access a database containing all content items and search or filter the content items based on the determined geofence or user segment to identify and/or select those content items associated with a specific segment and geographic area or perimeter specified in the geofence. The content items in the master list or database can include associations with specific businesses, people, locales, entities, or locations to enable the content-listing functions to identify content items having specific associations. In some configurations, the content items can include metadata defining their respective associations to enable the content-listing functions to search and identify content items having specific associations, as previously described. Here, the metadata of the content items can also include additional information which can be used by the content-listing functions to search, filter, identify, order, or rank the content items. For example, the metadata can include a respective, unique identifier associated with the content item; the content item's association (e.g., the relationship or association defined for that particular content item); the identity of the content item's associated place or entity; etc. As another example, the metadata can include a tag, a description of the content item or its associated place, a location of the content in storage, a location of the place(s) associated with the content item, a rank of the content item and/or the place associated with the content item, a label, a URL, a preference, an identity, a status, a category, usage information, a configuration, a capability, a playback configuration, etc.

The content-listing functions can rank or order items in any specific list of items. For example, the content-listing functions can rank items based on their specific location relative to another location, such as a current location of user terminal 102i, a predicted location of the user terminal 102i, a location of a locale, a location of a third party, a location of other devices, an identity of the user and/or the user terminal 102i, an identity of a place or locale, a history, a popularity, etc. In addition, the content-listing functions can rank items based on other factors, such as current or future context, segment information, user information, statistical information, etc.

In some configurations, the content database 220 can maintain content items for presentation at the user terminal 102i. The content database 220 can also maintain content associations with specific places, such as locales. Moreover, the content database 220 can maintain a database corresponding to specific items of content. Further, metadata can specify unique identifiers, location information, association information, ranking information, etc. The content database 220 can also maintain lists of content items filtered or selected based on specific rules or criteria. For example, the content database 220 can maintain lists of content items that are relevant to specific geographic areas, demographics, segments, circumstances, etc. The content database 220 can maintain specific content items for presentation at user terminal 102i.

User terminal 102i can select and/or present one or more items of content from the content database 220 based on a request, a preference, a rule, a condition, etc. For example, user terminal 102i can select one or more content items for presentation based on a preference in the preferences database 232, context information in the context database 230, segment information in the segment database 224, rules from the rules database 228, profile information from the profile database 222, etc.

In some embodiments, the content delivery system 106 can preselect the content package before a request is received. Yet in other embodiments, the user terminal 102i can preselect the content package, a portion of a content package, or conditions for selecting a content package, and transmit a request to the content delivery system 106 or the content database 220 accordingly.

In addition, user terminal 102i can transmit a request for content to the content delivery system 106, where the request includes information to be used by the content delivery system 106 in selecting the content to be provided to user terminal 102i. Alternatively, the user terminal 102i or a particular application of user terminal 102i, for example, can create a request to content management module 200 for presentation of content, where the request includes information for selecting such content. Such information included in a request can include, among other things, location information, profile information, segment information, campaign information, user information, encrypted information, timing or delivery information, preferences, context information, device information, context information, rules, etc. In some embodiments, user terminal 102i can transmit location information to the content delivery system 106, which can assist the content delivery system 106 in selecting invitational content or a content package to be delivered to user terminal 102i. User terminal 102i can also obtain location information from one or more components of the device, and use that information to select one or more content items from the content database 220.

In other embodiments, user terminal 102i can transmit segment information that includes content tags to the content delivery system 106, to assist the content delivery system 106 in delivering targeted content to user terminal 102i based on the segment information and the content tags. Likewise, user terminal 102i can also obtain segment information that includes content tags from the segment database 224, and use that information to select one or more content items from the content database 220. The segment information in the segment database 224 can be generated by segment module 208 or otherwise obtained from a separate device, such as content delivery system 106.

The segment module 208 can apply a set of user characteristics associated with a user (including segments to which a user has been previously assigned) to assign the user to one or more targeted segments. The segment module 208 can obtain the set of user characteristic values from the user profile database 222, from the user's activities during the current session, from user activities in a user history, from the context database 230, etc. The segment module 208 can assign a user to one or more defined targeted segments in the segment database 224, or alternatively, a user can be assigned to a custom targeted segment defined to meet specific goals of a content provider or campaign. Furthermore, the segment module 208 can use the set of user characteristics to determine a user engagement mode.

Based on the assigned segments and the user engagement mode, the user profile database 222 can be updated to reflect the segment assignments. Additionally, the user terminal 102i can use the segment assignments to select targeted content from the content database 220 or to request content from a separate device, such as content delivery system 106. In some cases, the user profile data in the user profile database 222 can change over time so the segment module 208 can be configured to periodically update the segment assignments in the user profile database 222. The segment assignment update can be triggered at specified intervals, upon detection of a change in the user profile database 222, and/or upon detection of a specified activity in the user terminal 102i. In some cases, a user can be assigned to more than one segment, and each segment can be ranked or ordered. Moreover, segments in the segment database 224 can also be prioritized as described above in FIG. 1.

The context database 230 can store information associated with a user's current context. For example, the context database 230 can store the current application or device usage information, browsing information, user activity, type of content being consumed by the user, user location information, user or device state or status, user movement, device information, etc. In some cases, the context database 230 can also store information associated with a predicted context of a user, such as a future context at a specific day and/or time. For example, the context database 230 can store information defining a predicted location of the user at a future time or information associated with a predicted interest or state of the user at the future time. In some cases, the information in the context database 230 can be used to assign or prioritize segments as previously mentioned. The information in the context database 230 can also be used to select content from the content database 220 or a remote content database, request content from a remote device, rank content, assemble content, etc. In some cases, the information from the context database 230 can also be combined with information obtained from the preferences database 232, the rules database 228, the segment database 224, the profile database 222, etc., to assign or prioritize segments, select content from the content database 220 or a remote content database, request content from a remote device, rank content, assemble content, etc. Moreover, the context module 210 can collect, analyze, manage, modify, and store the context information in the context database 230. For example, the context module 210 can monitor or log user activities, and generate context information for storage in the context database 230.

User terminal 102i can also include a user preferences module 202. The user preferences module 202 can allow a user to customize user preferences to his or her needs, filter the amount and type of content to be received by a user at user terminal 102i, etc. In some cases, users may be given the opportunity to opt-in or opt-out of receiving specific types of advertising, such as proximity-based advertising, for example.

In some cases, users may edit settings specifying the manner in which user terminal 102i announces its presence to proximity-based advertising appliances. For example, the user preferences module 202 can be configured to allow a user to make user terminal 102i “invisible” to proximity-based advertising appliances. In another example, the user preferences module 202 can be configured to make user terminal 102i visible and also allow user terminal 102i to disclose its user engagement mode, thus allowing proximity-based advertising appliances to send customized or targeted invitational content items to user terminal 102i.

In some cases, users may set preferences specifying a distance that defines a maximum or minimum proximity to a targeted establishment. To this end, the users may specify that they wish to only receive content associated with establishments or entities located within a specific distance of the user's current or future location. Examples include 0.5 miles, 1 mile, 2 miles, and 5 miles. Users in densely populated areas, or who are walking through a mall with many stores in close proximity to each other, may opt for a much shorter proximity range, in order to avoid being inundated with content that is outside the scope of their walking or commuting proximity while at a given user location point. In some embodiments, automatic ranging based on location and/or density of content providers can also be provided, rather than a user manually adjusting the details of proximity distance.

In some cases, user preferences can include a taxonomy of offers that a user wishes to receive. This can indicate that only specific product and service categories should be received. The taxonomy can be a set of verticals, or markets in which vendors offer goods or services, that a user allows engagement with. For example, a user may decide to receive content related to fine dining restaurants and retail shopping, but not from entertainment venues or bars. Here, the user can specify these preferences within the user preferences module 202. In some embodiments, the taxonomy can become more granular and specific as a user visits specific places. For example, if a user has been demonstrated to visit or engage with invitational content from entertainment venues at a threshold frequency, the taxonomy can allow the user to specify additional user preferences for allowing or disallowing invitational content from nightclubs, sports arenas, concert halls, movie theaters, and the like. In this way, the taxonomy can be dynamic and can learn from past behavior or preferences, and can also zoom-in on the categories of interest to expand the options for the user. However, in some embodiments, the user may also be able to turn off the use or presentation of subcategories or the dynamic learning of the taxonomy.

User preferences can also be used to determine how often offers may be received by a user, and when those offers may be received. The user preferences module 202 can limit offer notifications to only be displayed during certain hours of the day. For instance, in one embodiment a user may specify that invitational content should only be broadcasted between 9 AM and 8 PM on any given day, or one or more specified days. In another embodiment, a user may specify that invitational content should be received when the user is present in his office building or in a commercial venue, for example.

Rate throttling can also be an additional consideration. For example, a user can specify that no more than a set number of offers should be broadcasted or delivered in a given span of time, or in total. To illustrate, the user can specify that only up to a maximum of 5 offers should be delivered to that user in a week. The throttling can also, in some case, be coupled with other settings such as frequency settings. For example, the user can specify that only a maximum of 5 offers should be delivered in a week, but each offer should be at least 5 minutes apart or, alternatively, each offer should be no more than 5 minutes apart.

In some embodiments, a user can choose to “blacklist” a particular invitational content provider from broadcasting to them. In additional embodiments, a user can specify that the same invitational content provider should not broadcast to the user again for a specified period of time, e.g., ten minutes, one hour, one day, etc.

The user profile module 206 can store the preferences in the user preferences database 232. The preferences in the user preferences database 232 can also be associated with user profiles stored in the profile database 222.

The profile database 222 can store any profile information created and stored by the user profile module 206. The profile information can include profiles created for one or more users, devices, or accounts. The profiles can include information such as, for example, a user name, a user ID, address information for the user, user preferences or a reference to user preferences stored elsewhere (e.g., user preferences database 222), a user alias, contact information, identifying information, or any other profile information according to conventional profile methods.

The UUID database 226 can also store a unique user ID representing a user. The unique user ID can represent a user profile in the profile database 222. In some cases, the unique user ID can be used to identify a user without disclosing private information about the user, such as the user's name or social security number, for example.

The information in the various databases can be communicated to the content delivery system 106 through the network 104. To facilitate communications with the content delivery system 106 and/or any other device or component, the user terminal 102i can include a communications interface 120.

In some cases, however, information is maintained at the user terminal 102i to protect the user's privacy. Moreover, certain information transmitted from user terminal 102i to a separate device, such as content delivery system 106, can be degraded, encrypted, or otherwise hidden or protected for privacy reasons. For example, to protect the user's privacy interest in his or her current location, user terminal 102i can ensure to obscure location information sent to content delivery system 106.

Moreover, information sent to a server, such as content delivery system 106, can be obscured, conceal, or encrypted in many ways. For example, a portion of the information sent to the server can be omitted in order to provide the server incomplete information so as to protect the precise information from being fully revealed. To illustrate, instead of sending the exact location of user terminal 102i, the location information can merely specify the vicinity, as opposed to exact coordinates, of user terminal 102i to protect the exact location of user terminal 102i. Thus, if the user associated with user terminal 102i is at church, for example, but does not want that information disclosed, the degraded location of user terminal 102i can omit such details by providing a vicinity of the user, which may not precisely place user terminal 102i at the church. As another example, strings or symbols representing particular information can be sent to a server in lieu of the actual information to conceal the actual information represented by such strings or symbols. In some embodiments, user terminal 102i can use strings or symbols to represent segments or users, and send such strings or symbols to the server instead of the actual information. For example, user terminal 102i can send to the server unique user IDs from the UUID database 226, instead of actual names or real identifying information, to conceal and protect the identity of users. As another example, user terminal 102i can send to the server a string representing a segment for targeting content to hide the actual segment represented by the string. Other methods of concealing or encrypting information are also contemplated herein; however, these are provided as examples for the sake of clarity.

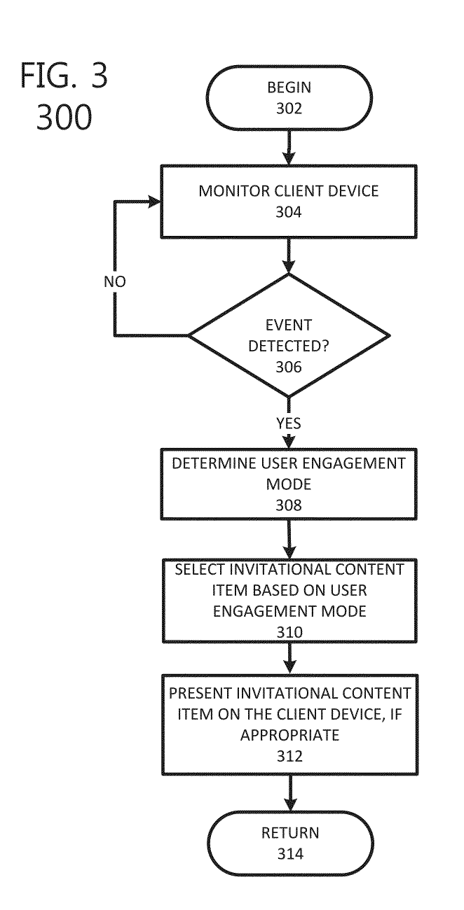

Turning now to FIG. 3, an operation of the process for selecting invitational content based on user engagement will be discussed in further detail. FIG. 3 is a flowchart of steps in an exemplary method 300 for selecting an invitational content item for presentation based on user engagement with a client device. Method 300 begins at step 302 and continues to step 304. At step 304, the client device, an example of which is user terminal 102ᵢ, commences monitoring the client device for any number of events.

In one instance, the events detected by the client device are associated with device configuration data. For example, the client device can detect the configuration of the audio routing on the device. The audio can be routed to a speaker, an earpiece, or an accessory that is coupled to a port that is configured to output audio signals, such as a headset jack. The audio can also be transmitted from the client device via a wireless interface to a personal area network such as a BLUETOOTH network. The client device can determine if it is presently paired with a BLUETOOTH headset and it can identify the make and model of the headset. In addition, the detected device configuration data can also include whether the audio interface is presently active and the volume setting on the device or the headset.

Another example of device configuration data is the selected alert mechanism of the client device. For example, a client device such as an IPHONE designed by Apple Inc. of Cupertino, Calif., can be configured to notify the device user of incoming messages or calls via a vibration, an audible alert set to a particular volume threshold, a visual indicator such as a light emitting diode (LED), a visual indication on a display, or any combination thereof.

Device configuration data can also include the configuration of one or more wireless interfaces on the device. For example, the device can be capable of connecting to a wireless local area network (WLAN) using a WI-FI interface. The configuration data can include information about the state of the WI-FI transceiver such as ON/OFF state, network affiliation, data throughput, trusted networks, etc. Another example of a wireless interface is Near-Field Communications (NFC). Again, the configuration data can include information about the NFC transceiver and NFC transactions completed on the device. Yet another example of a wireless interface is a cellular transceiver such as a Global System for Mobile Communications (GSM) transceiver, a Code Division Multiple Access (CDMA) transceiver or a Universal Mobile Telecommunications System (UMTS) transceiver. The configuration data can include information about the use of cellular interface, the network provider, and the location. A further example of a wireless interface is Global Positioning System (GPS). The configuration data can include information about the GPS receiver's current state. Relevant GPS states can include GPS off, GPS scanning for satellites, or GPS position fix acquired. Yet a further example of a wireless interface is a BLUETOOTH interface to a personal area network. The configuration data can include information about the BLUETOOTH network such as any network devices presently associated with the device and their respective master and slave status.

Device configuration data can also include the configuration of one or more wired interfaces. For example, the user device can have one or more ports for communicating with devices via Universal Serial Bus (USB), High-Definition Multimedia Interface (HDMI), FireWire, Ethernet, Digital Visual Interface (DVI), Video Graphics Array (VGA), etc. The device configuration data can gather information related to each of these interfaces and the devices or accessories that are associated with each respective interface.

Device configuration data can also include the software applications that are present on the device. For example, the device can have applications for playing music, watching video, playing games, shopping, dining, business, etc. The device configuration data can make an inventory of all of the applications on the device and the frequency with which they are used. The device configuration data can also identify applications that are presently running on the device and whether the application is active or simply running in the background. Furthermore, the application can be identified as one that was downloaded by the device user or originally present on the device.

In another instance, the events detected by the client device at step 304 are associated with a user device operation. In one example, a user device operation can be determined according to device movement. Device movement can be obtained from a sensor associated with the user's device such as a gyroscope, a magnetometer, an accelerometer, a pedometer, a light sensor, a GPS, a camera, etc. The device movement can be used to determine a type of motion such as stationary, holding, user propelled movement (i.e. walking or running), traveling in a vehicle, etc.

In another example, a user device operation can be associated with the device location. For instance, the user can be using the device at home, at work, in the car, at the gym, at a restaurant, etc. The location of the device can be determined in a number of different ways. For example, the user can be at home and the device can be associated with the user's home Wi-Fi network. Similarly, when the user is in the car the device can be paired with the vehicle's BLUETOOTH system.

The events detected as part of user device operation can also be determined according to the user's interaction with the device. One example of a user interaction is simply pressing or swiping a touch-activated screen or a button on the device. This interaction with the device can cause the device to “wake-up” from a low power or off state. Alternatively, pressing or swiping buttons or the screen can allow the user to navigate device menus, perform particular functions, or use applications that are loaded on the device.

For example, the user can launch an application on the device that plays music or a movie. The device can monitor the manner in which the user interacts with the application. A passive or inattentive user can allow the application to play music without skipping a song or providing feedback on a particular song. On the other hand, an active user can interact with the application by creating playlists, indicating a “liking” for a particular song, purchasing music, etc.

In addition to the user interaction with the application, the user device operation can also monitor the content of the particular application. In the music player example, the device operation can detect the type of music the user is playing. Similarly, if the user purchases a number of new software applications, the user device operation can include the act of purchasing the applications as well as the type of applications purchased.

The foregoing examples are provided to illustrate just some of the ways in which a user can interact with the device. A person skilled in the art will appreciate that a user's level of interaction can be ascertained from a number of different software applications such as games, web browsing, social media, email, instant messaging, etc. Accordingly, the device can maintain a history of the user's interaction with all applications and record the time corresponding to each event that is detected.

Returning to method 300, after step 304 wherein the client device is monitored, the method continues to step 306 to determine if an event was detected. If no event has been detected, the method returns to 304 for continued monitoring of the client device. If an event has been detected, the method proceeds to step 308 where it determines a user engagement mode.

The user engagement mode is based on the events previously detected at step 304. The user engagement mode is associated with the device configuration data and the user device operation. One example of a user engagement mode is playing music with the ITUNES application maintained by Apple Inc. of Cupertino, Calif., while using a stereo BLUETOOTH headset. Another example of a user engagement mode is updating FACEBOOK while associated with a home Wi-Fi network.

The user engagement mode can be based on any number of event combinations. In some embodiments, the present technology can maintain a matrix of events that can be used to establish the user engagement mode. Furthermore, the user engagement mode can be updated or changed in a dynamic fashion. For example, the user engagement mode can be modified according to the time elapsed since the last user action. The time elapsed can be a separate entry in the event matrix or it can be used as a factor that shifts the user engagement from one cell to another. In one embodiment, the changes to the user engagement mode can be made in real-time as the device constantly monitors events and keeps track of the elapsed time. Alternatively, the device can poll for a status at periodic intervals or it can receive a signal prompting it to check the status when a change occurs. For example, when the device user opens or closes a particular application, the application can generate an interrupt signal that prompts the device to update the user engagement mode.

In another embodiment, the client device can predict a future user engagement mode. Based on historical event data, the client device can determine the likelihood that a particular user engagement mode will be entered. For example, the historical event data can indicate that a particular device user tends to play music on the device between 1:00 PM and 2:00 PM. Based on this data, the device can predict that the user engagement mode will include a music playing component at those times and that it is unlikely the user engagement mode will include a music playing component at any other times.

After the user engagement mode is established, method 300 proceeds to step 310 where it can select an invitational content item based on the user engagement mode. In one embodiment, the invitational content item can be selected from a plurality of invitational content items that are stored on the memory of the device. Alternatively, the device can receive a plurality of invitational content items from an advertising server or from an appliance configured to broadcast invitational content items to devices that are within its range or associated with the same network. In either case, each of the invitational content items is evaluated as a candidate for presentation to the device user. In another embodiment, the device can communicate the user engagement mode to the ad server or the broadcast apparatus to specify the type of invitational content items the device can receive. Alternatively, the ad server or the broadcast apparatus can use the user engagement mode to select the types of invitational content items that are compatible with the user engagement mode.

In one example, each of the invitational content items is associated with at least one inclusion criterion and at least one exclusion criterion. The inclusion criterion and the exclusion criterion can be compared to the user engagement mode to filter the invitational content items. For example, a particular invitational content item can include an exclusion criterion that prohibits presenting the item when the high-audio speaker is off. If the present user engagement has the high-audio speaker off, this particular item can be discarded or it can be stored in memory for future consideration. Similarly, a particular invitational content item can include an inclusion criterion that requires a music playing application. If the present user engagement includes a music playing application, then this particular item is maintained as a candidate for presenting to the device user.

In addition, the inclusion criterion and the exclusion criterion can also include a time requirement. For example, the inclusion criterion can require that the invitational content item be presented in the first 10 minutes from the time the device user launches a music playing application. If this time elapses, the device can either discard the invitational content item or store it for future consideration. In this instance, the device can present an alternative invitational content item that satisfies the present user engagement mode or an invitational content item that is not targeted to a particular user engagement mode.

Furthermore, the exclusion criterion can also include a time requirement that prohibits presentation of the invitational content item at particular times. For example, the exclusion criterion can prohibit presentation of the invitational content item during the first minute of using the device or a particular application. Although the user is most likely engaged during the first minute, the presentation of invitational content at an early time can dissuade the user from continued use of the device or of the particular application.

The evaluation of the various invitational content items can also involve a confidence score for each of the items. The confidence score can be associated with different factors such as the inclusion criterion, the exclusion criterion, and one or more content tags associated with the item. For example, if the user engagement mode and the factors are a near-perfect match, the confidence score for that item can be assigned as “90%” or “Very High.” Likewise, if the factors are a poor match according to the engagement mode, the confidence score can be assigned as “10%” or “Very Low.”

Once the various invitational content items are evaluated and filtered, the device selects the particular item that is most suitable according to the present user engagement mode. In the event that the evaluation does not yield a perfect match, the device can select an invitational content item according to the confidence scores. Furthermore, the device can require a threshold confidence score for an invitational content item to be presented to the device user. If no invitational content items satisfy the threshold confidence score requirement, the device can opt to not present any of the invitational content items. Alternatively, the device can select one of the available invitational content items randomly. In still another alternative, the device can send a request for more invitational content items to a content delivery system such as an ad server or a local broadcasting device.

After the invitational content item is selected, the method proceeds to step 312 where it can present the selected item to the device user if it is appropriate to do so. For example, presentment of the selected item can be postponed or cancelled altogether if the device user is presently on a telephone call while driving a vehicle. Also, presentment of the selected item can be postponed or cancelled if the device user has poor network signal reception. In some embodiments, the device can also send a report to an advertising server informing it whether a particular invitational content item was presented. The report to the advertising server can include varying levels of details regarding the user engagement mode and how the invitational content item was selected. The device user can control this information according to privacy settings on the client device. In addition, the advertising server will also safeguard client information according to privacy policies and procedures, as discussed earlier.

Once the invitational content item is presented, the method continues to step 314, where it returns to previous processing, including repeating method 300.

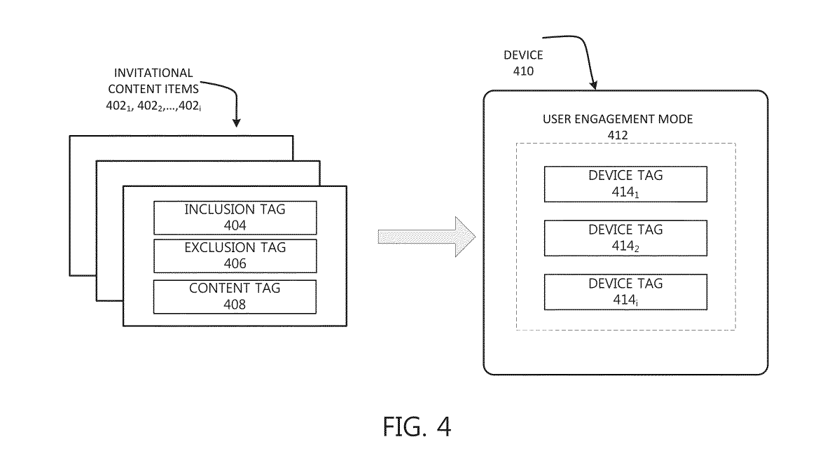

As previously discussed, the invitational content items can each include various tags that can be used to filter the items according to the user engagement mode of the device. Turning to FIG. 4, an exemplary set of invitational content items 402₁, 402₂ . . . 402ᵢ (collectively 402) and device 410 are illustrated. Invitational content items 402 can each include an inclusion tag 404, an exclusion tag 406, and a content tag 408. The inclusion tag 404 can include one or more inclusion criteria associated with presenting invitational content item 402. For example, inclusion tag 404 can include a parameter requiring the client device 410 to be paired to a BLUETOOTH headset when the invitational content item is presented. Likewise, exclusion tag 406 can include one or more criteria associated preventing the presentation of the invitational content item. For example, the exclusion tag 406 can include a parameter that inhibits presentation of the invitational content item when device 410 is not associated with a wireless network.

Invitational content item 402 can also include content tag 408. Content tag 408 can include additional information about the substance of the invitational content item. For example, content tag 408 can indicate that the invitational content item is targeting customers that are interested in a particular segment of the stock market. This content tag 408 can be used by device 412 to efficiently screen the invitational content item and to assign a confidence score.

Device 410 can be associated with user engagement mode 412. As discussed previously, the user engagement mode is determined by monitoring the device 410 for events that include device configuration data and user device operation. The user engagement mode can be maintained in the form of a matrix, or it can be further defined to yield device tags 414₁, 414₂ . . . 414ᵢ (collectively 414). The device tags 414 provide an alternative method to organize the information related to the user engagement mode.

In some embodiments, the device can use the device tags 414 to calculate a precision factor for the user engagement mode. The precision factor can be based on historical event data such as the number of events that have been detected, the type of events that have been detected, the amount of time since an event has been detected, etc. For example, a user that purchases a brand new device and uses it to browse the internet for sporting events can have device tags 414 associated with “web-browsing” and “sports.” However, the precision factor for the user engagement mode will likely be low because these events have only been detected one time.

In one embodiment, the device tags 414 and the tags included in the invitational content items (inclusion tag 404, exclusion tag 406, and content tag 408) include matching fields according to a standard. Consequently, the device 410 can easily compare the tags and determine if the invitational content item is compatible with the user engagement mode.

Alternatively, the fields of device tags 414 can be different from the fields of the tags that are packaged with invitational content items 402. In this instance, the device 410 can employ an algorithm to transform device tags 414 to conform to the respective tags from the item. In some embodiments, the device 410 can communicate with a server that can provide transformation parameters for device tags 414. Alternatively, the server can provide transformation parameters for the inclusion tag 404, the exclusion tag 406, or the content tag 408.

For example, content tag 408 can include fields that list “football, baseball, and basketball” while the device tags 414 can include “sports.” The content tag 408 can be converted to match with “sports” and the resulting comparison will likely yield a high confidence score. On the other hand, if the device tag 414 included “camping and kayaking,” perhaps the transformation parameter for the device would yield “outdoor recreation” while the transformation parameter for the invitational content item would yield “sports.” In this case, the device can assign a lower confidence score and deliver the item if there are no superior alternatives.

Once all of the tags are compatible to each other, device 410 can process the invitational content items 402 and select an appropriate item to present to the device user. The remaining invitational content items can either be discarded or saved for future consideration. The device 410 can make the decision to keep or discard an invitational content item 402 according to the present user engagement mode or a predicted future engagement mode. Alternatively, the decision to keep or discard an invitational content item 402 can be based on the particular confidence score that device 410 assigns to the item. For example, any item with a confidence score above “50%” can be saved for future consideration, while items that fall below that threshold are discarded. The device 410 can evaluate the invitational content item 402 at the time that the device 410 needs to present invitational content item 402 or the device 410 can evaluate the invitational content item 402 as part of a screening process that takes place when invitational content item 402 is received at device 410.

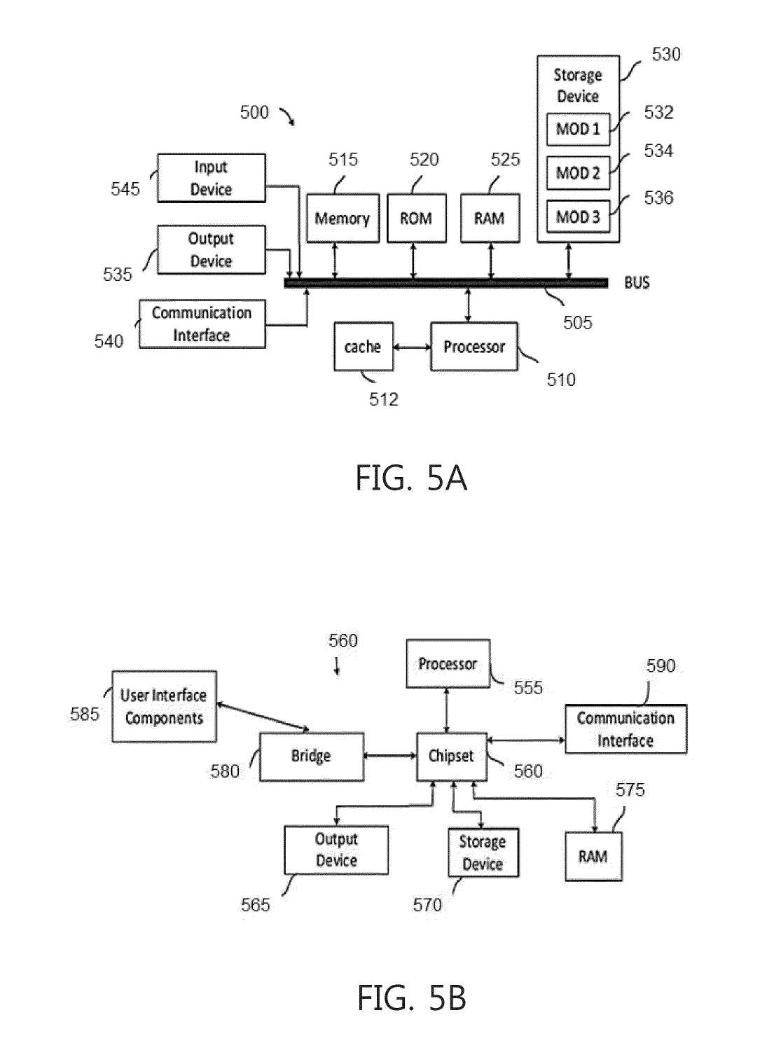

FIG. 5A illustrates a conventional system bus computing system architecture 500 wherein the components of the system are in electrical communication with each other using a bus 505. Exemplary system 500 includes a processing unit (CPU or processor) 510 and a system bus 505 that couples various system components including the system memory 515, such as read only memory (ROM) 520 and random access memory (RAM) 525, to the processor 510. The system 500 can include a cache of high-speed memory connected directly with, in close proximity to, or integrated as part of the processor 510. The system 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other system memory 515 may be available for use as well. The memory 515 can include multiple different types of memory with different performance characteristics. The processor 510 can include any general purpose processor and a hardware module or software module, such as module 1 532, module 2 534, and module 3 536 stored in storage device 530, configured to control the processor 510 as well as a special-purpose processor where software instructions are incorporated into the actual processor design. The processor 510 may essentially be a completely self-contained computing system, containing multiple cores or processors, a bus, memory controller, cache, etc. A multi-core processor may be symmetric or asymmetric.

To enable user interaction with the computing device 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems can enable a user to provide multiple types of input to communicate with the computing device 500. The communications interface 540 can generally govern and manage the user input and system output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof.

The storage device 530 can include software modules 532, 534, 536 for controlling the processor 510. Other hardware or software modules are contemplated. The storage device 530 can be connected to the system bus 505. In one aspect, a hardware module that performs a particular function can include the software component stored in a computer-readable medium in connection with the necessary hardware components, such as the processor 510, bus 505, display 535, and so forth, to carry out the function.

FIG. 5B illustrates a computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 555, representative of any number of physically and/or logically distinct resources capable of executing software, firmware, and hardware configured to perform identified computations. Processor 555 can communicate with a chipset 560 that can control input to and output from processor 555. In this example, chipset 560 outputs information to output 565, such as a display, and can read and write information to storage device 570, which can include magnetic media, and solid state media, for example. Chipset 560 can also read data from and write data to RAM 575. A bridge 580 for interfacing with a variety of user interface components 585 can be provided for interfacing with chipset 560. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 560 can also interface with one or more communication interfaces 590 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 555 analyzing data stored in storage 570 or 575. Further, the machine can receive inputs from a user via user interface components 585 and execute appropriate functions, such as browsing functions by interpreting these inputs using processor 555.

It can be appreciated that exemplary systems 500 and 550 can have more than one processor 510 or be part of a group or cluster of computing devices networked together to provide greater processing capability.

For clarity of explanation, in some instances the present technology may be presented as including individual functional blocks including functional blocks including devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Claim language reciting “at least one of” a set indicates that one member of the set or multiple members of the set satisfy the claim. Tangible computer-readable storage media, computer-readable storage devices, or computer-readable memory devices, expressly exclude media such as transitory waves, energy, carrier signals, electromagnetic waves, and signals per se.

We claim:

1. A computer-implemented method comprising:
detecting, via a processor, at least one of a plurality of events on a client device, the plurality of events comprising at least one device configuration event and at least one device operation event;
determining a user engagement mode for the client device based on the at least one of the plurality of events;
selecting at least one invitational content item from a plurality of invitational content items stored on the client device based on the user engagement mode; and
presenting the at least one invitational content item at the client device.

2. The computer-implemented method of claim 1, further comprising:
comparing at least one inclusion criterion and at least one exclusion criterion associated with each of the plurality of invitational content items with the user engagement mode;
filtering each of the plurality of invitational content items according to the comparison.

3. The computer-implemented method of claim 1, wherein the at least one device operation event includes launching or using at least one application on the client device.

4. The computer-implemented method of claim 1, wherein the at least one device operation event comprises a device movement type obtained from one or more device sensors, wherein the device movement type comprises at least one of stationary, walking, and running.

5. The computer-implemented method of claim 1, wherein the at least one device configuration event comprises at least one of a wireless configuration, an audio configuration, and a notification configuration.

6. The computer-implemented method of claim 1, wherein the user engagement mode is further based on a time elapsed from the at least one of the plurality of events.

7. The computer-implemented method of claim 1, further comprising:
sending an acknowledgment that the at least one invitational content item was presented at the client device.

8. The computer-implemented method of claim 1, further comprising:
predicting a future user engagement mode based on a history of the user engagement mode;
receiving one or more new invitational content items;
evaluating the one or more new invitational content items according to the user engagement mode and the future user engagement mode;
discarding a portion of the one or more new invitational content items that are incompatible with the user engagement mode and the future user engagement mode.

9. A computer-implemented method comprising:
detecting, via a processor, at least one of a plurality of events on a client device, the plurality of events comprising at least one device configuration event and at least one device operation event;
computing a set of client device tags based on the at least one of the plurality of events;
selecting at least one invitational content item from a plurality of invitational content items stored on the client device based on the set of client device tags; and
presenting the at least one invitational content item at the client device.

10. The computer-implemented method of claim 9, wherein each of the plurality of invitational content items is associated with at least one inclusion tag and at least one exclusion tag.

11. The computer-implemented method of claim 10, wherein the selecting comprises:
comparing the set of client device tags with the at least one inclusion tag and the at least one exclusion tag associated with each of the plurality of invitational content items;
using the comparison to determine a confidence score for each of the plurality of invitational content items; and
filtering each of the plurality of invitational content items according to its confidence score.

12. The computer-implemented method of claim 9, wherein the set of client device tags is further based on a time elapsed from the at least one of the plurality of events.

13. The computer-implemented method of claim 9, wherein the at least one device operation event includes launching or using at least one application on the client device.

14. The computer-implemented method of claim 9, wherein the at least one device operation event comprises a device movement type obtained from one or more device sensors, wherein the device movement type comprises at least one of stationary, walking, and running.

15. The computer-implemented method of claim 9, wherein the at least one device configuration event comprises at least one of a wireless configuration, an audio configuration, and a notification configuration.

16. The computer-implemented method of claim 9, further comprising:
sending an acknowledgment that the at least one invitational content item was presented at the client device.

17. A non-transitory computer-readable storage medium having stored therein instructions which, when executed by a processor, cause the processor to perform operations comprising:
detecting, via a processor, at least one of a plurality of events on a client device, the plurality of events comprising at least one device configuration event and at least one device operation event;
determining a user engagement mode for the client device based on the at least one of the plurality of events;
selecting at least one invitational content item from a plurality of invitational content items stored on the client device based on the user engagement mode; and
presenting the at least one invitational content item at the client device.

18. The computer-readable storage medium of claim 17, wherein each of the plurality of invitational content items is associated with at least one presentation criterion, the at least one presentation criterion comprising at least one of an inclusion criterion and an exclusion criterion.

19. The computer-readable storage medium of claim 18, further comprising:
formulating a filter function based on the user engagement mode;
filtering each of the plurality of invitational content items according to the at least one presentation criterion.

20. A client device, comprising:
a communications interface;
a processor; and
a computer-readable medium, having stored thereon a plurality of instructions for causing the processor to perform operations comprising:
detecting, via a processor, at least one of a plurality of events on the client device, the plurality of events comprising at least one device configuration event and at least one device operation event;
computing a set of client device tags based on the at least one of the plurality of events and the at least one device configuration;
selecting at least one invitational content item from a plurality of invitational content items stored on the client device based on the user engagement mode; and
presenting the at least one invitational content item at the client device.

21. The client device of claim 20, wherein each of the plurality of invitational content items is associated with at least one inclusion tag and at least one exclusion tag.

22. The client device of claim 20, wherein the selecting comprises:
comparing the at least one inclusion tag and the at least one exclusion tag associated with each of the plurality of invitational content items with the set of client device tags;
filtering each of the plurality of invitational content items according to the comparison.

23. The client device of claim 20, wherein the set of client device tags is further based on a time elapsed from the at least one of the plurality of events.

24. The client device of claim 20, wherein the at least one device operation event includes launching or using at least one application on the client device.
